(19) United States
(12) Patent Application Publication
(10) Pub. No.: US 2002/0160653 A1
(43) Pub. Date: Oct. 31, 2002

(54) Circuit board assembly with device status-indicating capability

(76) Inventor: Chien-Ming Hu, Tainan Hsien (TW)

Correspondence Address: NIXON & VANDERHYE P.C., 8th Floor, 1100 North Glebe Road, Arlington, VA, 22201-4714, US

(21) Appl. No.: 09/840,876

(22) Filed: Apr. 25, 2001

(51) Int. Cl. H01R 3/00

(52) U.S. Cl. 439/490; 340/635; 361/600

(57) ABSTRACT

A circuit board assembly includes a control unit and an electrical connector which are mounted on a circuit board and which are connected electrically to each other. The electrical connector has an electronic device mounted removably thereon. The control unit is connected electrically to the electronic device via the electrical connector, and is operable so as to detect the operating state of the electronic device. A status indicator is mounted on the circuit board and is disposed adjacent to the electrical connector. The status indicator is connected electrically to and is controlled by the control unit to generate a status signal according to the operating state of the electronic device on the electrical connector.

### BACKGROUND OF THE INVENTION

1. Field of the Invention

The invention relates to a circuit board assembly, more particularly to a circuit board assembly capable of indicating the operating state of an electronic device thereon.

2. Description of the Related Art

Referring to FIG. 1, a conventional computer motherboard 1 is shown have a pair of peripheral component interconnect (PCI) connectors 101, four industry standard architecture (ISA) connectors 102, a central processing unit (CPU) connector 103, and three memory card connectors 104.

Referring to FIG. 2, the memory card connector 104 is formed with an insert slot 1041 for engaging removably one edge of a memory card 107. The memory card connector 104 is further formed with a pair of pivot blocks 105 at opposite ends of the insert slot 1041. Card fasteners 106 are mounted pivotally and respectively on the pivot blocks 105, and engage opposite sides of the memory card 107.

As mentioned hereinbefore, the conventional computer motherboard 1 has more than one memory card connector 104 thereon. As such, when the memory card 107 on one of the memory card connectors 104 breaks down and is to be replaced, the memory cards 107 on the conventional computer motherboard 1 have to be taken out one at a time for inspection. It is thus inconvenient to find a defective memory card 107 on the conventional computer motherboard 1.

### SUMMARY OF THE INVENTION

Therefore, the main object of the present invention is to provide a circuit board assembly capable of indicating the operating state of an electronic device that is mounted thereon to facilitate locating and replacement of the electronic device when the latter breaks down.

According to the present invention, a circuit board assembly comprises a circuit board, a control unit mounted on the circuit board, and at least one electrical connector mounted on the circuit board and connected electrically to the control unit. The electrical connector has an electronic device mounted removably thereon. The control unit is connected electrically to the electronic device via the electrical connector, and is operable so as to detect the operating state of the electronic device. Each of at least one status indicator is mounted on the circuit board and is disposed adjacent to a respective electrical connector. The status indicator is connected electrically to and is controlled by the control unit to generate a status signal according to the operating state of the electronic device on the respective electrical connector.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view showing a conventional computer motherboard;

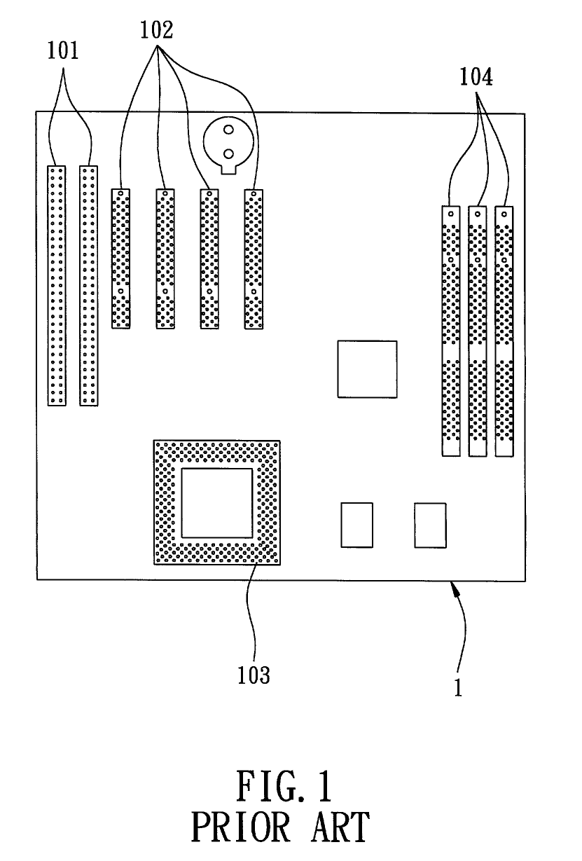

FIG. 2 is a perspective view showing a memory card connector for mounting a memory card on the conventional computer motherboard of FIG. 1;

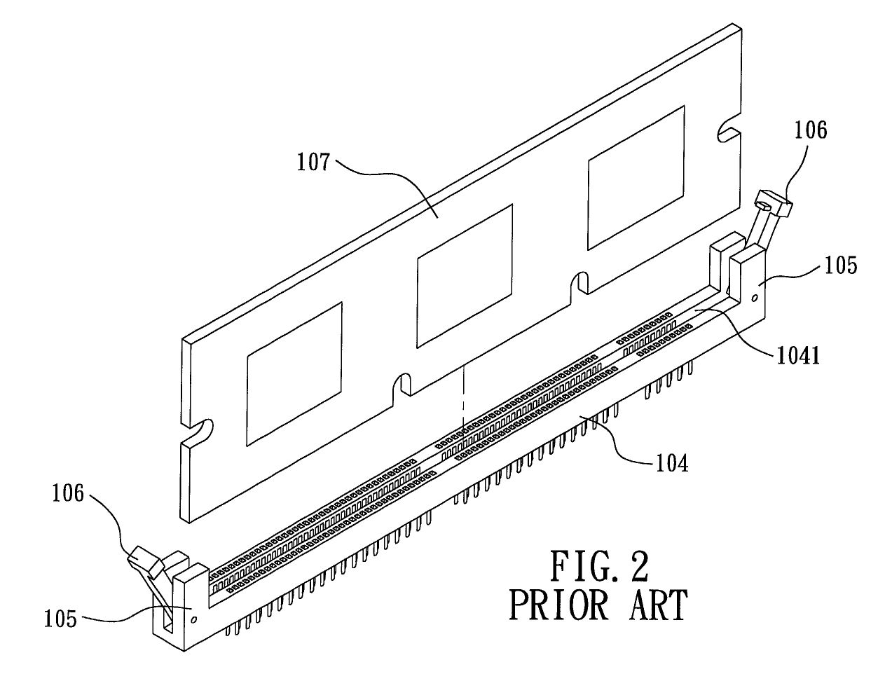

FIG. 3 is a fragmentary partly exploded perspective view of the preferred embodiment of a circuit board assembly according to the present invention;

FIG. 4 is a schematic view showing an electronic device and an electrical connector of the preferred embodiment;

FIG. 5 is a partly sectional view of the preferred embodiment, taken along line V-V in FIG. 3; and

FIG. 6 is a schematic circuit block diagram illustrating the connection among a control unit, an electronic device, an electrical connector and a status indicator of the preferred embodiment.

### DETAILED DESCRIPTION OF THE PREFERRED EMBODIMENT

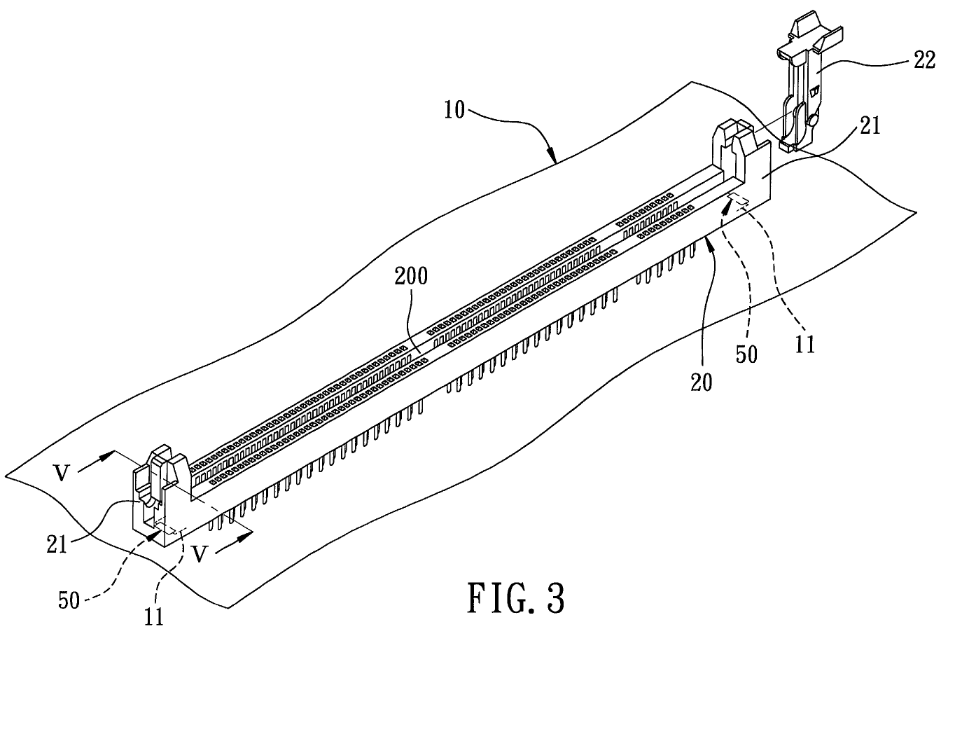

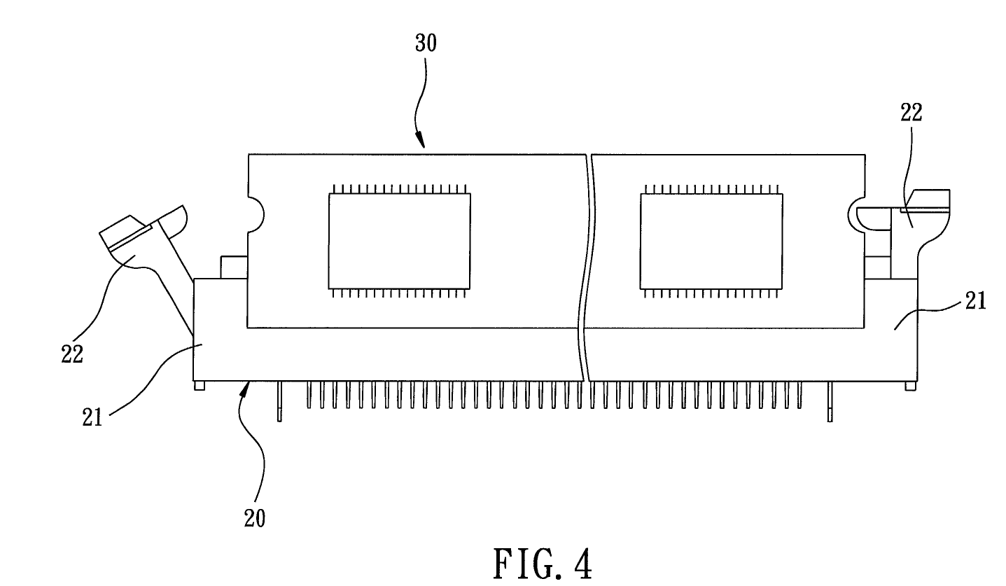

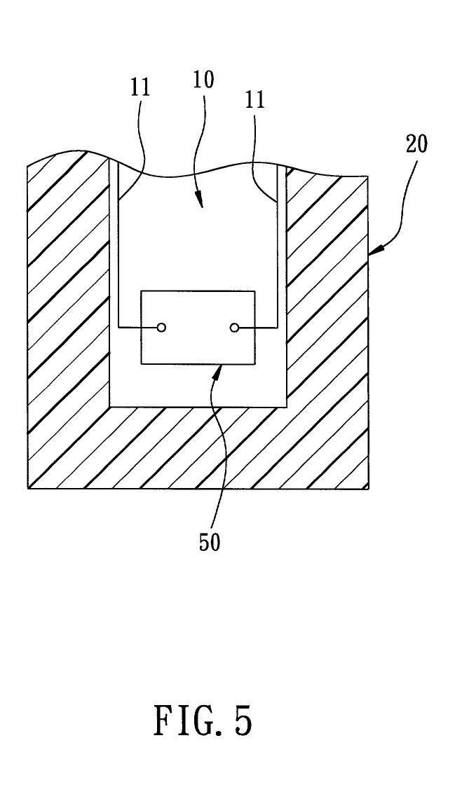

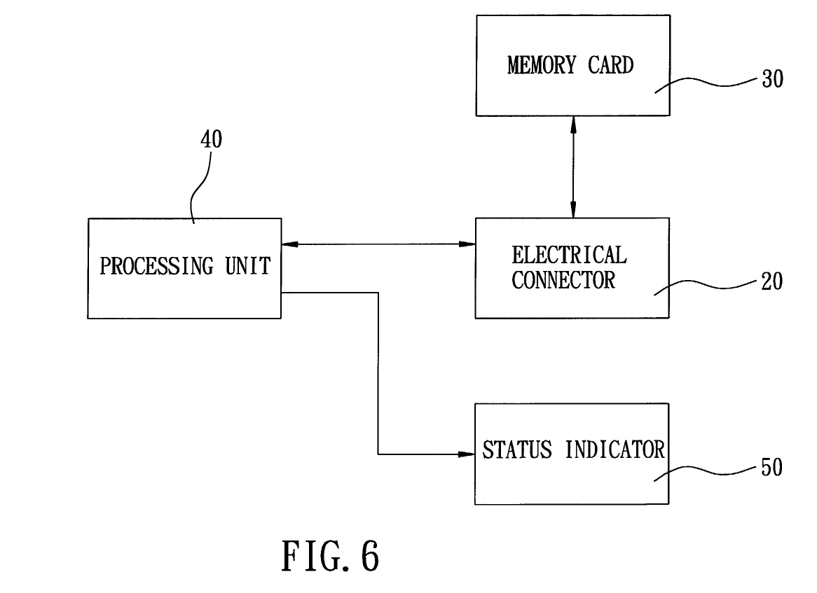

Referring to FIGS. 3 to 6, the preferred embodiment of a circuit board assembly according to the present invention is shown to comprise a circuit board 10, and a control unit, such as a processing unit 40, mounted on the circuit board 10. Electrical connectors 20 (only one is shown) are mounted on the circuit board 10 and are connected electrically to the processing unit 40. Each of the electrical connectors 20 has an electronic device, in the form of a memory card 30, mounted removably thereon. In the present embodiment, each of the electrical connectors 20 is a card-edge electrical connector and is formed with an insert slot 200 for engaging removably one edge of the memory card 30. Each of the electrical connectors 20 is further formed with a pair of pivot blocks 21 at opposite ends of the insert slot 200. Card fasteners 22, which are made of a transparent material, are mounted pivotally and respectively on the pivot blocks 21, and engage opposite sides of the memory card 30. The processing unit 40 is connected electrically to the memory cards 30 via the electrical connectors 20, and is operable so as to detect the operating states of the memory cards 30.

In the circuit board assembly of this invention, status indicators 50 are mounted on the circuit board 10 and are disposed adjacent to the electrical connectors 20, respectively. The status indicators 50 are connected electrically to the processing unit 40 via circuit traces 11 on the circuit board 10, and are controlled by the processing unit 40 to generate a status signal according to the operating state of the memory card 30 on the respective one of the electrical connectors 20. In this embodiment, the status indicators 50 are light emitting devices, which are controlled by the processing unit 40 to generate the status signal when the memory card 30 on the respective one of the electrical connectors 20 is defective, and which are disposed on the circuit board 10 below one of the pivot blocks 21 of the respective one of the electrical connectors 20.

In use, when power is supplied to the circuit board assembly of this invention, the processing unit 40 will be enabled to detect the operating states of the memory cards 30 on the electrical connectors 20. Upon detection by the processing unit 40 that the memory card 30 on one of the electrical connectors 20 is defective, the processing unit 40 will activate a corresponding one of the status indicators 50, thereby enabling the latter to generate the status signal that is visible via the transparent card fasteners 22 on said one of the electrical connectors 20. As such, locating and replacement of defective memory cards 30 is facilitated in the circuit board assembly of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A circuit board assembly, comprising:
a circuit board;
a control unit mounted on said circuit board;
at least one electrical connector mounted on said circuit board and connected electrically to said control unit, said electrical connector having an electronic device mounted removably thereon, said control unit being connected electrically to said electronic device via said electrical connector and being operable so as to detect operating state of said electronic device; and
at least one status indicator mounted on said circuit board and disposed adjacent to a respective said electrical connector, said status indicator being connected electrically to and being controlled by said control unit to generate a status signal according to the operating state of said electronic device on the respective said electrical connector.

2. The circuit board assembly of claim 1, wherein said status indicator is a light emitting device.

3. The circuit board assembly of claim 2, wherein said status indicator is controlled by said control unit to generate the status signal when said electronic device on the respective said electrical connector is defective.

4. The circuit board assembly of claim 3, wherein said electronic device is a memory card, and said electrical connector is a card-edge electrical connector formed with an insert slot for engaging removably one edge of said electronic device.

5. The circuit board assembly of claim 4, wherein said electrical connector has a pair of card fasteners mounted pivotally thereon at opposite ends of said insert slot, said card fasteners engaging opposite sides of said electronic device, one of said card fasteners being made of a transparent material, said status indicator being disposed on said circuit board below said one of said card fasteners of the respective said electrical connector.

6. The circuit board assembly of claim 1, wherein said control unit is a processing unit.
